(19) United States
(12) Patent Application Publication
(10) Pub. No.: US 2026/0212196 A1
(43) Pub. Date: Jul. 23, 2026

(54) SYSTEM AND METHOD FOR PERFORMING AGENT-BASED SIMULATION WITH LEARNING AGENT MODELS

(71) Applicant: JPMorgan Chase Bank, N.A., New York, NY (US)

(72) Inventors: Kshama DWARAKANATH, Union City, CA (US); Svitlana VYETRENKO, Berkeley, CA (US); Peyman TAVALLALI, Monroe Township, NJ (US); Tucker Richard BALCH, Suwanee, GA (US)

(73) Assignee: JPMorgan Chase Bank, N.A., New York, NY (US)

(21) Appl. No.: 19/029,868

(22) Filed: Jan. 17, 2025

(51) Int. Cl. G06N 3/092

(52) U.S. Cl. CPC G06N 3/092

(57) ABSTRACT

Various methods and processes, apparatuses or systems, and media for performing a multi-agent simulation for capturing reactionary actions by a downstream computer agent are disclosed. The present disclosure provides generating a simulation model with at least two independent computer agents with at least one communication provided between the at least two independent computer agents; initializing each of the at least two independent computer agents; independently performing, via machine learning, reinforcement learning for each of the at least two independent computer agents; executing the simulation model for performing a simulation until a stable state is established in the simulation; initiating at least one exogeneous shock to the simulation model after the stable state is established in the simulation; and capturing reactionary data from the at least two independent computer agents.

### TECHNICAL FIELD

This disclosure generally relates to providing an agent-based simulation with learning agent models. More specifically, the present disclosure relates to providing a multiple agent simulation model with independent reinforcement learning by the multiple agents.

### BACKGROUND

The developments described in this section are known to the inventors. However, unless otherwise indicated, it should not be assumed that any of the developments described in this section qualify as prior art merely by virtue of their inclusion in this section, or that these developments are known to a person of ordinary skill in the art.

Conventional simulation tools for modeling economic systems, such as Dynamic Stochastic General Equilibrium (DSGE) models, are limited to reliance on representative agent assumptions, which may not account for heterogeneity and bounded rationality that may be common in real agents, such as households and various firms/organizations.

Further, conventional agent based models do not incorporate adaptation, learning or objective-maximizing behaviors for various actors. When agents are learning, the conventional agent based models focus on a single agent type, such as a household or firm, and assume that other actors will not change their behavior in response to actions of the learning agent. Accordingly, inaccurate simulation results often result from the conventional agent based models that rely on static conditions of downstream or intervening parties, which may be removed from reality.

### SUMMARY

The present disclosure, through one or more of its various aspects, embodiments, and/or specific features or sub-components, provides, among other features, a method for performing a multi-agent simulation for capturing reactionary actions by a downstream computer agent. The method includes generating, by a processor, a simulation model with at least two independent computer agents with at least one communication provided between the at least two independent computer agents; initializing each of the at least two independent computer agents; independently performing, by the processor and via machine learning, reinforcement learning for each of the at least two independent computer agents; executing, by the processor, the simulation model for performing a simulation over a certain horizon; initiating, by the processor, at least one exogeneous shock to the simulation model after the stable state is established in the simulation; and capturing, by the processor, reactionary data from the at least two independent computer agents.

In some embodiments, each of the at least two independent computer agents are limited to its respective internal states.

In some embodiments, a first independent computer agent of the at least two independent computer agents is configured to receive a message from a second independent computer agent to obtain select data of the second independent computer agent, and the second independent computer agent of the at least two independent computer agents is configured to receive a message from the first independent computer agent to obtain select data of the first independent computer agent.

In some embodiments, each of the at least two independent computer agents is configured to optimize its respective reward.

In some embodiments, each of the at least two independent computer agents is configured to independently perform reinforcement learning.

In some embodiments, each of the at least two independent computer agents is of a different agent type among a plurality of agent types.

In some embodiments, the plurality of agent types includes a households agent type, a firms agent type, a government agent type, a central bank agent type.

In some embodiments, the stable state is determined to be reached when rewards of all learning agents improve and plateau.

In some embodiments, each of the at least two independent computer agents includes four or more different agent types.

In some embodiments, at least one of the plurality of agent types includes a plurality of agents with differing heterogeneity parameters.

In some embodiments, the stable state is determined at each predetermined time step after the simulation model is executed.

In some embodiments, the at least one exogeneous shock includes an advent of a new technology, a disease outbreak, a natural disaster, a global conflict.

In some embodiments, the reactionary data includes a modified action performed by at least one of the at least two independent computer agents in response to the exogenous shock.

In some embodiments, the differing heterogeneity parameters are acquired from at least one of literature and real world data.

In some embodiments, the at least one exogeneous shock is embedded in the simulation model.

In some embodiments, the method further includes acquiring, by the processor, data for building the simulation model, the data including historical data and/or reference data; and identifying a plurality of data entities included in the acquired data, dataflows between the plurality of data entities, types of the data entities and variations within the types of data entities, wherein the at least two independent computer agents correspond to the plurality of data entities identified.

In some embodiments, the method further includes selecting a granularity level of the multi-agent simulation.

In some embodiments, the granularity level includes a country level, a state or regional level and an international level.

In some embodiments, a system for performing a multi-agent simulation for capturing reactionary actions by a downstream computer agent is disclosed. The system may include: a processor; and a memory operatively connected to the processor via a communication interface, the memory storing computer readable instructions, when executed, causes the processor to perform: generating a simulation model with at least two independent computer agents with at least one communication provided between the at least two independent computer agents; initializing each of the at least two independent computer agents; executing the simulation model for performing a simulation until a stable state is established in the simulation; initiating at least one exogeneous shock to the simulation model after the stable state is established in the simulation; capturing reactionary data from the at least two independent computer agents; and independently performing, via machine learning, reinforcement learning for each of the at least two independent computer agents.

In some embodiments, a non-transitory computer readable medium configured to store instructions for performing a multi-agent simulation for capturing reactionary actions by a downstream computer agent is disclosed. The instructions, when executed, may cause a processor to perform the following: generating a simulation model with at least two independent computer agents with at least one communication provided between the at least two independent computer agents; initializing each of the at least two independent computer agents; executing the simulation model for performing a simulation until a stable state is established in the simulation; initiating at least one exogeneous shock to the simulation model after the stable state is established in the simulation; capturing reactionary data from the at least two independent computer agents; and independently performing, via machine learning, reinforcement learning for each of the at least two independent computer agents.

### BRIEF DESCRIPTION OF THE DRAWINGS

The present disclosure is further described in the detailed description which follows, in reference to the noted plurality of drawings, by way of non-limiting examples of preferred embodiments of the present disclosure, in which like characters represent like elements throughout the several views of the drawings.

FIG. 1 illustrates a computer system for implementing a multi-agent simulation with independent learning agents' (MASILA) system in accordance with an embodiment.

FIG. 2 illustrates a diagram of a network environment for implementing a MASILA system in accordance with an embodiment.

FIG. 3 illustrates a system configuration diagram for implementing a MASILA system in accordance with an embodiment.

FIG. 4 illustrates a method for providing multi-agent simulation with independent learning agents in accordance with an embodiment.

FIGS. 5A-5C illustrate multi-agent simulation performed at differing levels of organizations accordance with embodiments.

FIGS. 6A-6C illustrate discounted cumulative rewards demonstrating training convergence in accordance with embodiments.

FIGS. 7A-7D illustrate a scenario that shows an impact of heterogeneous household skills on their learned preferences to work at different firms in accordance with embodiments.

FIGS. 8A-8D illustrate a scenario that shows an impact of a positive production shock to one of two firms in comparison to the second firm in accordance with embodiments.

FIGS. 9A-9C illustrate examples of scenarios to simulate impact of reduction in farm inventory buffers, and increase in capital adequacy requirements in accordance with embodiments.

### DETAILED DESCRIPTION

Through one or more of its various aspects, embodiments and/or specific features or sub-components of the present disclosure, are intended to bring out one or more of the advantages as specifically described above and noted below.

The examples may also be embodied as one or more non-transitory computer readable media having instructions stored thereon for one or more aspects of the present technology as described and illustrated by way of the examples herein. The instructions in some examples include executable code that, when executed by one or more processors, cause the processors to carry out steps necessary to implement the methods of the examples of this technology that are described and illustrated herein.

As is traditional in the field of the present disclosure, example embodiments are described, and illustrated in the drawings, in terms of functional blocks, units and/or modules. Those skilled in the art will appreciate that these blocks, units and/or modules are physically implemented by electronic (or optical) circuits such as logic circuits, discrete components, microprocessors, hard-wired circuits, memory elements, wiring connections, and the like, which may be formed using semiconductor-based fabrication techniques or other manufacturing technologies. In the case of the blocks, units and/or modules being implemented by microprocessors or similar, they may be programmed using software (e.g., microcode) to perform various functions discussed herein and may optionally be driven by firmware and/or software. Alternatively, each block, unit and/or module may be implemented by dedicated hardware, or as a combination of dedicated hardware to perform some functions and a processor (e.g., one or more programmed microprocessors and associated circuitry) to perform other functions. Also, each block, unit and/or module of the example embodiments may be physically separated into two or more interacting and discrete blocks, units and/or modules without departing from the scope of the inventive concepts. Further, the blocks, units and/or modules of the example embodiments may be physically combined into more complex blocks, units and/or modules without departing from the scope of the present disclosure.

According to exemplary aspects, present disclosure provides a multi-agent simulation model system that is capable of capturing reactionary data by various independent computer agents in the simulation model at subsequent levels, which was unable to be captured under the conventional single agent-based simulation models. While the conventional single agent-based simulation models may be able to capture immediate results to other data entities in response to an action by the single agent, the conventional single agent based simulation models are unable to capture subsequent reactions or modified actions of the impacted data entities, which may consequentially affect the single agent further downstream. In contrast, since the multi-agent simulation model allows for each of the agents to operate independently to optimize its respective benefits and perform independent reinforcement learning, downstream effects may be more accurately captured rather than being limited to only the results to the impacted data entities.

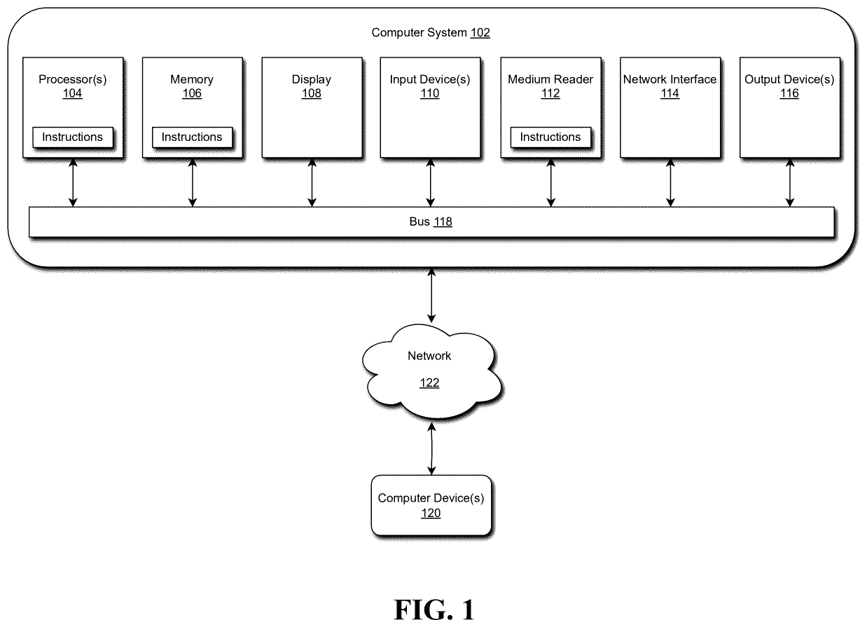

FIG. 1 is a system 100 for use in implementing a multi-agent simulation with independent learning agent (MASILA) system in accordance with an embodiment. The system 100 is generally shown and may include a computer system 102, which is generally indicated.

The computer system 102 may include a set of instructions that may be executed to cause the computer system 102 to perform any one or more of the methods or computer-based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks or cloud environment. Even further, the instructions may be operative in such cloud-based computing environment.

In a networked deployment, the computer system 102 may operate in the capacity of a server or as a client user computer in a server-client user network environment, a client user computer in a cloud computing environment, or as a peer computer system in a peer-to-peer (or distributed) network environment. The computer system 102, or portions thereof, may be implemented as, or incorporated into, various devices, such as a personal computer, a tablet computer, a set-top box, a personal digital assistant, a mobile device, a palmtop computer, a laptop computer, a desktop computer, a communications device, a wireless smart phone, a personal trusted device, a wearable device, a global positioning satellite (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term system shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 is an article of manufacture and/or a machine component. The processor 104 is configured to execute software instructions in order to perform functions as described in the various embodiments herein. The processor 104 may be a general-purpose processor or may be part of an application specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in, or coupled to, a single device or multiple devices.

The computer system 102 may also include a computer memory 106. The computer memory 106 may include a static memory, a dynamic memory, or both in communication. Memories described herein are tangible storage mediums that can store data and executable instructions, and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions may be read by a computer. Memories as described herein may be random access memory (RAM), read only memory (ROM), flash memory, electrically programmable read only memory (EPROM), electrically erasable programmable read-only memory (EEPROM), registers, a hard disk, a cache, a removable disk, tape, compact disk read only memory (CD-ROM), digital versatile disk (DVD), floppy disk, or any other form of storage medium known in the art. Memories may be volatile or non-volatile, secure and/or encrypted, unsecure and/or unencrypted. Of course, the computer memory 106 may comprise any combination of memories or a single storage.

The computer system 102 may further include a display 108, such as a liquid crystal display (LCD), an organic light emitting diode (OLED), a flat panel display, a solid-state display, a cathode ray tube (CRT), a plasma display, or any other known display.

The computer system 102 may also include at least one input device 110, such as a keyboard, a touch-sensitive input screen or pad, a speech input, a mouse, a remote control device having a wireless keypad, a microphone coupled to a speech recognition engine, a camera such as a video camera or still camera, a cursor control device, a GPS device, a visual positioning system (VPS) device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed input devices 110 are not meant to be exhaustive and that the computer system 102 may include any additional, or alternative, input devices 110.

The computer system 102 may also include a medium reader 112 which is configured to read any one or more sets of instructions, e.g., software, from any of the memories described herein. The instructions, when executed by a processor, may be used to perform one or more of the methods and processes as described herein. In a particular embodiment, the instructions may reside completely, or at least partially, within the memory 106, the medium reader 112, and/or the processor 104 during execution by the computer system 102.

Furthermore, the computer system 102 may include any additional devices, components, parts, peripherals, hardware, software, or any combination thereof which are commonly known and understood as being included with or within a computer system, such as, but not limited to, a network interface 114 and an output device 116. The output device 116 may be, but is not limited to, a speaker, an audio out, a video out, a remote-control output, a printer, or any combination thereof.

Each of the components of the computer system 102 may be interconnected and communicate via a bus 118 or other communication link. As shown in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, serial advanced technology attachment, etc.

The computer system 102 may be in communication with one or more additional computer devices 120 via a network 122. The network 122 may be, but is not limited to, a local area network, a wide area network, the Internet, a telephony network, a short-range network, or any other network commonly known and understood in the art. The short-range network may include, for example, infrared, near field communication, ultraband, or any combination thereof. Those skilled in the art appreciate that additional networks 122 which are known and understood may additionally or alternatively be used and that networks 122 are not limiting or exhaustive. Also, while the network 122 is shown in FIG. 1 as a wireless network, those skilled in the art appreciate that the network 122 may also be a wired network.

The additional computer device 120 is shown in FIG. 1 may be a personal computer. However, those skilled in the art appreciate that, in alternative embodiments of the present application, the computer device 120 may also be a laptop computer, a tablet PC, a personal digital assistant, a mobile device, a palmtop computer, a desktop computer, a communications device, a wireless telephone, a personal trusted device, a web appliance, a server, or any other device that is capable of executing a set of instructions, sequential or otherwise, that specify actions to be taken by that device. Of course, those skilled in the art appreciate that the above-listed devices are merely exemplary and that the device 120 may be any additional device or apparatus commonly known and understood in the art without departing from the scope of the present application. For example, the computer device 120 may be the same or similar to the computer system 102. Furthermore, those skilled in the art similarly understand that the device may be any combination of devices and apparatuses.

Of course, those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

In some embodiments, the MASILA module implemented by the system 100 may allow for a MASILA module to capture not only results to a data entity or computer agent in response to an action by a computer agent as provided in the conventional single agent computer simulation models, but also reactionary actions by the impacted data entity or computer agent, which may resultingly cause a chain reaction to other interconnected data entities or computer agents.

In accordance with various embodiments of the present disclosure, the methods described herein may be implemented using a hardware computer system that executes software programs. Further, in a non-limited embodiment, implementations can include distributed processing, component/object distributed processing, and an operation mode having parallel processing capabilities. Virtual computer system processing may be constructed to implement one or more of the methods or functionalities as described herein, and a processor described herein may be used to support a virtual processing environment.

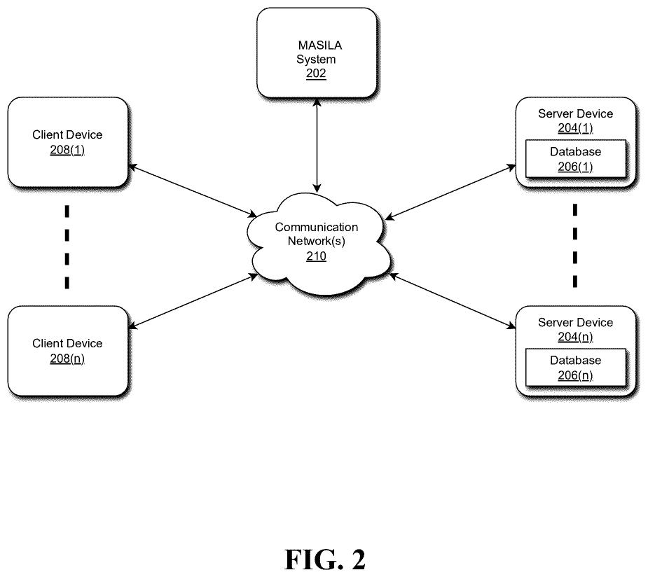

Referring to FIG. 2, a schematic of a network environment 200 for implementing a MASILA is illustrated.

In some embodiments, the above-described problems associated with conventional single agent simulation model may be overcome by implementing a MASILA system 202 as illustrated in FIG. 2 that may be configured for implementing a MASILA module configured for generating a simulation model with at least two independent computer agents with at least one communication provided between the at least two independent computer agents; initializing each of the at least two independent computer agents; executing the simulation model for performing a simulation until a stable state is established in the simulation; initiating at least one exogeneous shock to the simulation model after the stable state is established in the simulation; capturing reactionary data from the at least two independent computer agents; and independently performing, via machine learning, reinforcement learning for each of the at least two independent computer agents.

The MASILA system 202 may include one or more computer system 102s, as described with respect to FIG. 1, which in aggregate provides the necessary functions.

The MASILA system 202 may store one or more applications that can include executable instructions that, when executed by the MASILA system 202, cause the MASILA system 202 to perform actions, such as to transmit, receive, or otherwise process network messages, for example, and to perform other actions described and illustrated below with reference to the figures. The application(s) may be implemented as modules or components of other applications. Further, the application(s) may be implemented as operating system extensions, modules, plugins, or the like.

Even further, the application(s) may be operative in a cloud-based computing environment. The application(s) may be executed within or as virtual machine(s) or virtual server(s) that may be managed in a cloud-based computing environment. Also, the application(s), and even the MASILA system 202 itself, may be located in virtual server(s) running in a cloud-based computing environment rather than being tied to one or more specific physical network computing devices. Also, the application(s) may be running in one or more virtual machines (VMs) executing on the MASILA system 202. Additionally, in one or more embodiments of this technology, virtual machine(s) running on the MASILA system 202 may be managed or supervised by a hypervisor.

In the network environment 200 of FIG. 2, the MASILA system 202 may be coupled to a plurality of server devices 204(1)-204(n) that hosts a plurality of databases 206(1)-206(n), and also to a plurality of client devices 208(1)-208(n) via communication network(s) 210. A communication interface of the MASILA system 202, such as the network interface 114 of the computer system 102 of FIG. 1, operatively couples and communicates between the MASILA system 202, the server devices 204(1)-204(n), and/or the client devices 208(1)-208(n), which are all coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the MASILA system 202, the server devices 204(1)-204(n), and/or the client devices 208(1)-208(n) may be coupled together via other topologies. Additionally, the network environment 200 may include other network devices such as one or more routers and/or switches, for example, which are well known in the art and thus will not be described herein.

By way of example only, the communication network(s) 210 may include local area network(s) (LAN(s)) or wide area network(s) (WAN(s)), and can use TCP/IP over Ethernet and industry-standard protocols, although other types and/or numbers of protocols and/or communication networks may be used. The communication network(s) 210 in this example may employ any suitable interface mechanisms and network communication technologies including, for example, teletraffic in any suitable form (e.g., voice, modem, and the like), Public Switched Telephone Network (PSTNs), Ethernet-based Packet Data Networks (PDNs), combinations thereof, and the like.

The MASILA system 202 may be a standalone device or integrated with one or more other devices or apparatuses, such as one or more of the server devices 204(1)-204(n), for example. In one particular example, the MASILA system 202 may be hosted by one of the server devices 204(1)-204(n), and other arrangements are also possible. Moreover, one or more of the devices of the MASILA system 202 may be in the same or a different communication network including one or more public, private, or cloud networks, for example.

The plurality of server devices 204(1)-204(n) may be the same or similar to the computer system 102 or the computer device 120 as described with respect to FIG. 1, including any features or combination of features described with respect thereto. For example, any of the server devices 204(1)-204(n) may include, among other features, one or more processors, a memory, and a communication interface, which are coupled together by a bus or other communication link, although other numbers and/or types of network devices may be used. The server devices 204(1)-204(n) in this example may process requests received from the MASILA system 202 via the communication network(s) 210 according to the HTTP-based and/or JavaScript Object Notation (JSON) protocol, for example, although other protocols may also be used.

The server devices 204(1)-204(n) may be hardware or software or may represent a system with multiple servers in a pool, which may include internal or external networks. The server devices 204(1)-204(n) hosts the databases 206(1)-206(n) that are configured to store metadata sets, data quality rules, and newly generated data.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a master/slave approach, whereby one of the network computing devices of the server devices 204(1)-204(n) operates to manage and/or otherwise coordinate operations of the other network computing devices.

The server devices 204(1)-204(n) may operate as a plurality of network computing devices within a cluster architecture, a peer-to peer architecture, virtual machines, or within a cloud architecture, for example. Thus, the technology disclosed herein is not to be construed as being limited to a single environment and other configurations and architectures are also envisaged.

The plurality of client devices 208(1)-208(n) may also be the same or similar to the computer system 102 or the computer device 120 as described with respect to FIG. 1, including any features or combination of features described with respect thereto. Client device in this context refers to any computing device that interfaces to communications network(s) 210 to obtain resources from one or more server devices 204(1)-204(n) or other client devices 208(1)-208(n).

In some embodiments, the client devices 208(1)-208(n) in this example may include any type of computing device that can facilitate the implementation of the MASILA system 202 that may efficiently provide a MASILA module configured for generating a simulation model with at least two independent computer agents with at least one communication provided between the at least two independent computer agents; initializing each of the at least two independent computer agents; executing the simulation model for performing a simulation until a stable state is established in the simulation; initiating at least one exogeneous shock to the simulation model after the stable state is established in the simulation; capturing reactionary data from the at least two independent computer agents; and independently performing, via machine learning, reinforcement learning for each of the at least two independent computer agents.

The client devices 208(1)-208(n) may run interface applications, such as standard web browsers or standalone client applications, which may provide an interface to communicate with the MASILA system 202 via the communication network(s) 210 in order to communicate user requests. The client devices 208(1)-208(n) may further include, among other features, a display device, such as a display screen or touchscreen, and/or an input device, such as a keyboard, for example.

Although the network environment 200 with the MASILA system 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as may be appreciated by those skilled in the relevant art(s).

One or more of the devices depicted in the network environment 200, such as the MASILA system 202, the server devices 204(1)-204(n), or the client devices 208(1)-208(n), for example, may be configured to operate as virtual instances on the same physical machine. For example, one or more of the MASILA system 202, the server devices 204(1)-204(n), or the client devices 208(1)-208(n) may operate on the same physical device rather than as separate devices communicating through communication network(s) 210. Additionally, there may be more or fewer MASILA system s 202, server devices 204(1)-204(n), or client devices 208(1)-208(n) than illustrated in FIG. 2. In some embodiments, the MASILA system 202 may be configured to send code at run-time to remote server devices 204(1)-204(n), but the disclosure is not limited thereto.

In addition, two or more computing systems or devices may be substituted for any one of the systems or devices in any example. Accordingly, principles and advantages of distributed processing, such as redundancy and replication also may be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, Packet Data Networks (PDNs), the Internet, intranets, and combinations thereof.

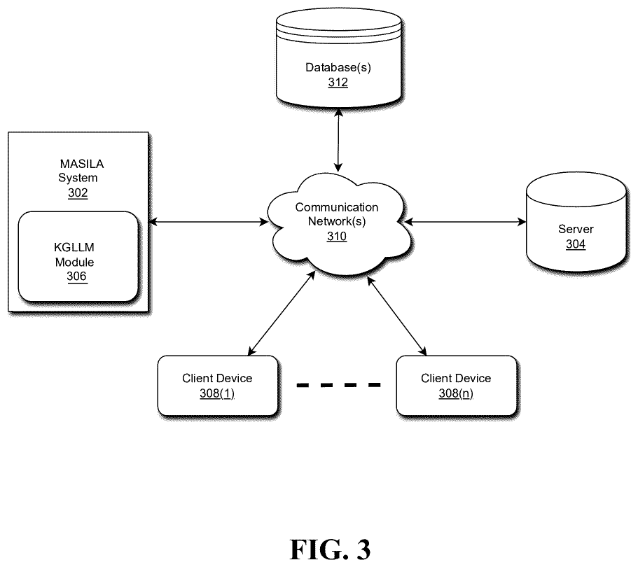

FIG. 3 illustrates a system diagram for implementing a MASILA system in accordance with an embodiment.

As illustrated in FIG. 3, the system 300 may include a MASILA system 302 within which a MASILA module 306 is embedded, a server 304, a database(s) 312, a plurality of client devices 308(1) . . . 308(n), and a communication network 310.

In some embodiments, the MASILA system 302 including the MASILA module 306 may be connected to the server 304, and the database(s) 312 via the communication network 310. The MASILA system 302 may also be connected to the plurality of client devices 308(1) . . . 308(n) via the communication network 310, but the disclosure is not limited thereto. The database(s) 312 may include one or more rule databases.

In an embodiment, the MASILA system 302 is described and shown in FIG. 3 as including the MASILA module 306, although it may include other rules, policies, modules, databases, or applications, for example. In some embodiments, the database(s) 312 may be configured to store ready to use modules written for each API for all environments. Although only one database is illustrated in FIG. 3, the disclosure is not limited thereto. Any number of desired databases may be utilized for use in the disclosed invention herein. The database(s) 312 may be a mainframe database, a log database that may produce programming for searching, monitoring, and analyzing machine-generated data via a web interface, etc., but the disclosure is not limited thereto. In addition, the database(s) 312 may store the large code bases models as directed graphs and graph metrics and graph centrality measures.

In some embodiments, the MASILA module 306 may be configured to receive real-time feed of data from the plurality of client devices 308(1) . . . 308(n) and secondary sources via the communication network 310.

The MASILA module 306 may be configured to perform: generating a simulation model with at least two independent computer agents with at least one communication provided between the at least two independent computer agents; initializing each of the at least two independent computer agents; executing the simulation model for performing a simulation until a stable state is established in the simulation; initiating at least one exogeneous shock to the simulation model after the stable state is established in the simulation; capturing reactionary data from the at least two independent computer agents; and independently performing, via machine learning, reinforcement learning for each of the at least two independent computer agents, but the disclosure is not limited thereto.

The plurality of client devices 308(1) . . . 308(n) are illustrated as being in communication with the MASILA system 302. In this regard, the plurality of client devices 308(1) . . . 308(n) may be “clients” (e.g., customers) of the MASILA system 302 and are described herein as such. Nevertheless, it is to be known and understood that the plurality of client devices 308(1) . . . 308(n) need not necessarily be “clients” of the MASILA system 302, or any entity described in association therewith herein. Any additional or alternative relationship may exist between either or both of the plurality of client devices 308(1) . . . 308(n) and the MASILA system 302, or no relationship may exist.

The first client device 308(1) may be, for example, a smart phone. Of course, the first client device 308(1) may be any additional device described herein. The second client device 308(n) may be, for example, a personal computer (PC). Of course, the second client device 308(n) may also be any additional device described herein. In some embodiments, the server 304 may be the same or equivalent to the server device 204 as illustrated in FIG. 2.

The process may be executed via the communication network 310, which may comprise plural networks as described above. For example, in an embodiment, one or more of the plurality of client devices 308(1) . . . 308(n) may communicate with the MASILA system 302 via broadband or cellular communication. Of course, these embodiments are merely exemplary and are not limiting or exhaustive.

The plurality of client devices 308(1) . . . 308(n) may be the same or similar to any one of the client devices 208(1)-208(n) as described with respect to FIG. 2, including any features or combination of features described with respect thereto. The MASILA system 302 may be the same or similar to the MASILA system 202 as described with respect to FIG. 2, including any features or combination of features described with respect thereto.

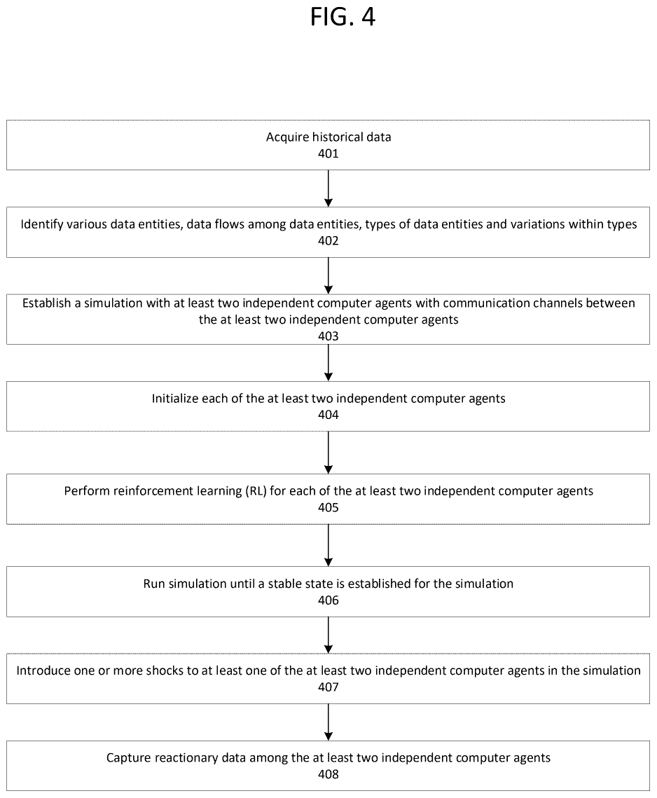

FIG. 4 illustrates a method for providing multi-agent simulation with independent learning agents in accordance with an embodiment.

According to exemplary aspects, a multi-agent based simulator equipped with reinforcement learning capabilities is provided. More specifically, each agent in the multi-agent simulator may be equipped with independent reinforcement learning capabilities. Reinforcement learning may deal with problems where an agent learns to act in an uncertain, dynamic environment through trial-and-error to maximize its objectives over a horizon. When multiple computer agents are attempting to learn to act in a common environment, they may each introduce non-stationary and (potential) partial observability for other agents. In consideration of the above noted behavior, the multi-agent based simulator may be configured to limit each of the computer agents to its internal states, and to receive information from other computer agents via transmitted messages. Moreover, the multi-agent based simulator may further embed agent heterogeneity and exogenous shocks where agent requests and utilize information from other computer agents to decide on an action. In an example, the multi-agent based simulator may be an agent-based simulator for economic systems. However, aspects of the present disclosure are not limited thereto, such that the multi-agent based simulator may be applied to various systems, including manufacturing systems, supply chain systems and the like.

According to example aspects, the reinforcement learning capabilities may be provided through one or more toolkits that facilitate developing and testing reinforcement learning algorithms, run training simulations, speed up the learning process for algorithms, and compare such algorithms. According to further aspects, each agent in the multi-agent based simulator may refer to a computerized agent. Moreover, each agent in the multi-agent based simulator correspond to one or more computerized models.

According to exemplary aspects, a multi-agent simulator implemented by the MASILA system may be formed for heterogenous data entities, such as heterogeneous households, heterogenous firms, central bank and government agents that may be subject to exogenous, stochastic shocks. An interaction between computer agents in the multi-agent simulator may define production and consumption of goods, as well as flow of other assets or information. Each computer agent may be configured to act according to fixed, rule-based strategies or learn their respective strategies based on interactions with other independently run computer agents. In an example, the multi-agent simulator may be grounded by choosing agent heterogeneity parameters based on one or more reference resources, such as academic literature and real world information, while configuring their action space in accordance with real world data. Based on such practice, the multi-agent simulator may help to maintain closeness to reality for simulated data in absence of publicly available, labeled data per computer agent. Moreover, the multi-agent simulator may facilitate the use of reinforcement learning strategies for the computer agents.

In operation 401, historical data and/or reference data for generating a simulation model may be acquired from various data sources. In an example, data sources may include government sources, trusted data aggregators, publicly available data sources, third parties, one or more firms, academic or news/journal articles, and the like. According to example aspects, historical data may be updated as more recent data is generated and collected.

In operation 402, based on the acquired data, various data entities may be identified along with data flows between the identified data entities. Moreover, types of the data entities may also be identified based on the data flows. In an example, data entities may include consumers, which may include one or more households. The households may be consumers of goods and provide skilled labor for the production of goods. Data entities may further include firms that may utilize labor from the households to produce goods and pay wages. Moreover, data entities may further include a central bank that may monitor price inflation and production to set interest rates for savings and borrowing costs for households. Moreover, the central bank may set interest rates for borrowing costs for firms. Data entities may also include a government entity, which may collect income taxes from households and firms that could potentially be redistributed as tax credits. Although four types of data entities are described herein, aspects of the present disclosure are not limited thereto, such that different entity types may be present.

Moreover, according to further aspects, each of the data entity types may include various classes that may be identified. For example, household data entity types may be different with respect to income, education, skillset and the like. Firm data entity types may be different with respect to its respective sector, amount of labor required, skill level required and the like.

In operation 403, a simulation model is generated with at least two independent computer agents via the MASILA system for performing simulation. According to exemplary aspects, an agent or computer agent may refer to an entity that senses its environment to make a goal-oriented decision that is implemented by taking an action on an environment. Moreover, the MASILA system may be an agent-based interactive discrete event simulator with different types of agents. The computer agents in the MASILA system may have access to their internal states, and receive information about other agents via messages via one or more communication channels. In an example, a simulation kernel may handle message passing between agents, and run simulations over a specified time horizon while maintaining timestamps for all agents and simulation itself.

Although each of the independent computer agents are limited to their internal states, the independent computer agents may communication with one another by messages via the identified communication channels. More specifically, at least since agents may be limited to accessing their internal states, any information from other computer agents is to be requested using messages. Recipients of messages may respond by sharing a part of their internal states with the sender. For example, the household agent may send a message to each firm agent asking for its price and wage. The firm agent may respond by sending that information which is used in the household agent's observation. This scenario may apply to each feature in an agent's observation that is external to itself, and may pertain to all agents.

Each of the independent computer agent may cause a reaction based on a received input, such as a message from another independent computer agent. However, unlike a conventional simulation model that operates on a single computer agent based on expected inputs from steady state entities, the multi-agent simulation provided via the MASILA system may operate on each independent agents that operates from other independent agents, that may react based on its received input or inputs. In the MASILA system, because each independent agent may provide a reactionary output in response to a received input, an independent agent receiving the reactionary output from another independent agent may provide its own reactionary output, rather than an output based on a steady state assumed by the conventional simulation system.

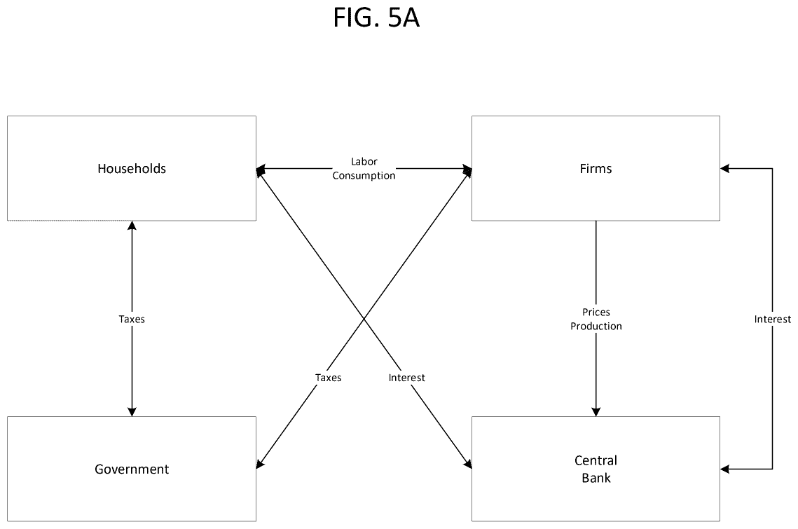

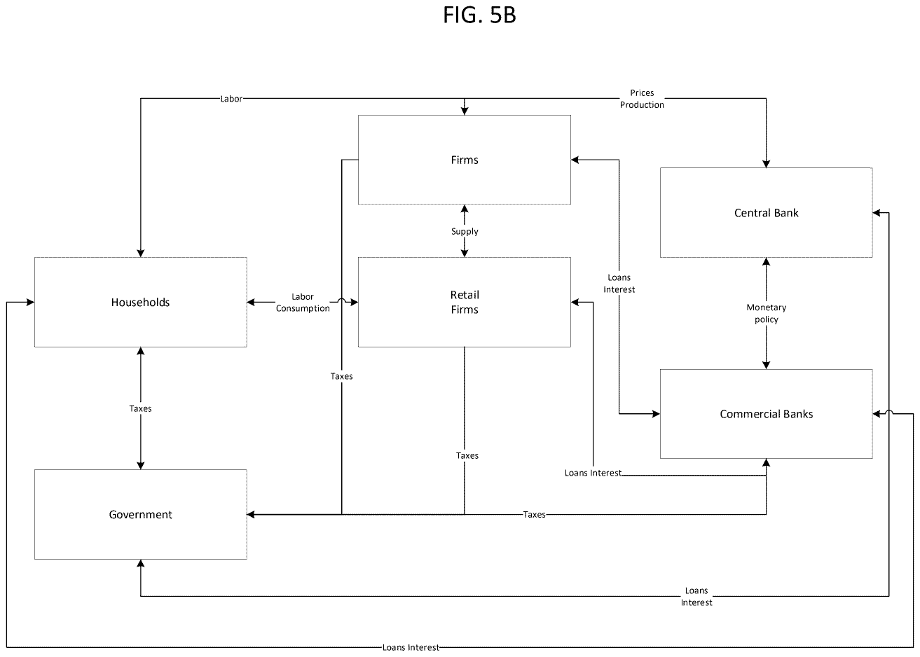

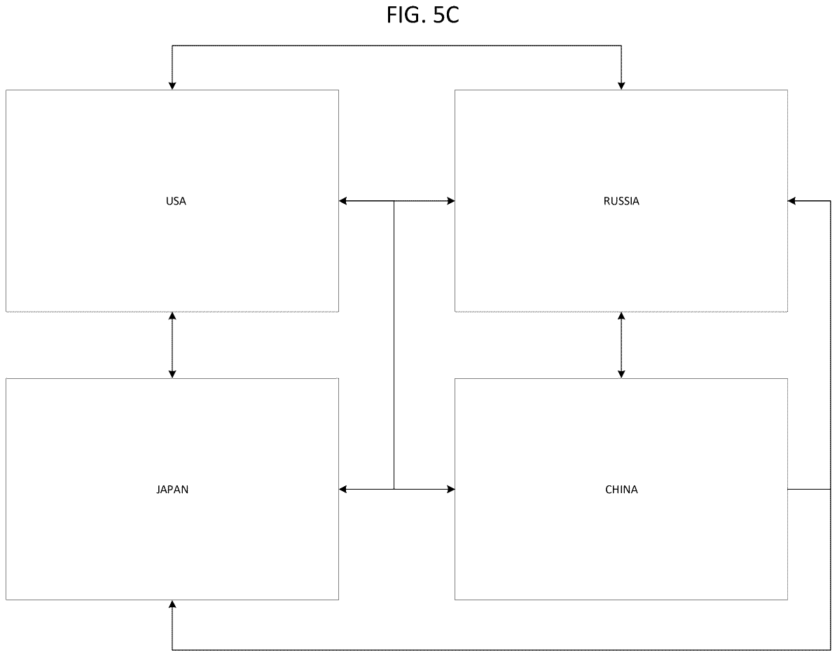

Examples of multi-agent simulation configuration are discussed in further detail with respect to FIGS. 5A-5C.

In operation 404, each of the computer agents in the simulation may be initialized with default heterogeneity parameters. According to example aspects, drawbacks associated with conventional representative agent or single agent type may be overcome by introducing heterogeneity to one or more agent types. In an example, agent heterogeneity parameters (e.g., heterogeneity in income, wealth or temporal preferences) and their actions spaces may be chosen in reference to various literature and real world values (e.g., minimum, median wages for households as provided by government sources). In an example, household heterogeneity may be defined in terms of labor disutility and age. Utilization of real world values allows the multi-agent based simulator to maintain closeness to reality for the simulated data in absence of publicly available, labeled data per agent.

In an example, heterogeneity may be obtained from one or more reference datasets or data sources. Further, the heterogeneity parameters may be provided by different data sources for different types or classes of computer agents. For every simulation run, one must specify the simulation horizon in predetermined time periods, and the number of agents within each category along with agent heterogeneity parameters if different from their default values.

For example, at the beginning of the simulation (e.g., where time step t=0), a household agent may start with $0 in savings, a firm agent may start with 0 units of inventory, which may set default prices and wages for t=0. Further, the central bank agent may also set a default interest rate for t=0, and the government entity agent may set the default tax rate and give out $0 of tax credits for t=0.

In operation 405, reinforcement learning may be performed by each of the at least two computer agents. In an example, reinforcement learning may be performed by the government agent or the central bank agent to learn an optimal monetary policy describing the interest rate towards meeting inflation and productivity targets. Conventional simulation technology applied reinforcement learning to a single agent type in isolation of other independent computer agents in a reactive simulation environment, and thus, limits the amount of adaptation, learning and quality of learning provided to the single agent type and outputs an ineffective or inaccurate policy as a result. By utilizing multi-agent reinforcement learning to each of the independent computer agents in the simulation, strategies for each of the independent computer agent types may be learned in a dynamic, reactive simulation environment even with stochasticity.

In operation 406, the simulation is executed until a stable state is established for the simulation. In an example, the stable state may be deemed to be reached when a general equilibrium is reached, such as when supply equals demand for goods and labor within a reference tolerance in an economic simulation model. According to example aspects, each of the computer agents may operate to optimize its respective objective. In an example, an objective of a household agent may be to maximize its discounted sum of utilities over time.

In reaching a stable state, for example, at each time step after initialization (e.g., t>0), each household agents may observe tax rate, tax credits, interest rate, prices, wages to decide on labor hours and requested consumption. Then, each firm agent may use labor to produce goods, fulfil consumption, update its inventory, and pay taxes on profits to the government agent. Subsequently, each household agent may then update its savings based on realized consumption and pay taxes to the government agent. Central bank agent monitors firm prices and productions to set interest rate. Lastly, the government agent collects taxes from the household and firm agents according to a set tax rate and distributes corresponding credits to the household agents. The above noted operations may be repeated for a number of time periods according to a predetermined interval (e.g., each quarter) until a stable state is reached. In an example, the stable state may be deemed to be reached when a general equilibrium is reached, such as when supply equals demand for goods and labor within a reference tolerance in an economic simulation model.

According to example aspects, every household i has a different skill level per firm j, given by ωᵢⱼ. In this scenario, an impact of household skills on their preference to provide labor to firms is provided. In an example, an economy with 2 heterogeneously skilled households, 2 heterogeneous firms, and central bank as learning agents over a horizon of 10 years (40 quarters) is provided. In this example, firm 1 may represent a technology firm that is less labor intensive while firm 2 may represent an agriculture firm that is more labor intensive. Here, household 1 may be more skilled at firm 1, with both households having similar skills for firm 2. Both households may have=0.33, ν=0.5, μ=1.0 and βH=0.99 with heterogeneous skills given by:

$$[ \begin{matrix}{ω}_{11} & {ω}_{12} \\ {ω}_{21} & {ω}_{22}\end{matrix} ] = [ \begin{matrix}2 & 1 \\ 1 & 1\end{matrix} ] .$$

Both firms have β_{F}=0.99, exogenous shock process parameters of

$$ρ = 0.97 , \overline{ε} = 0 ,$$

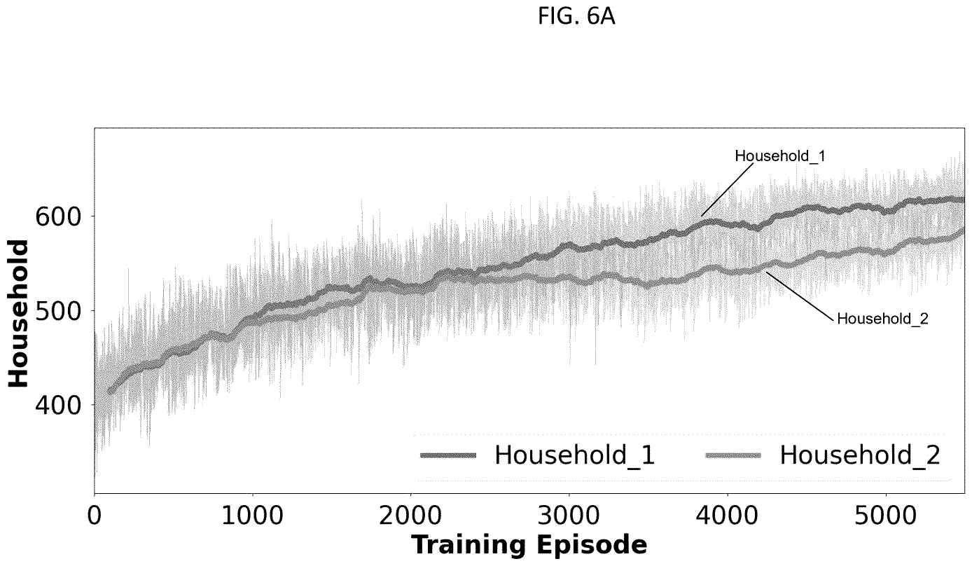

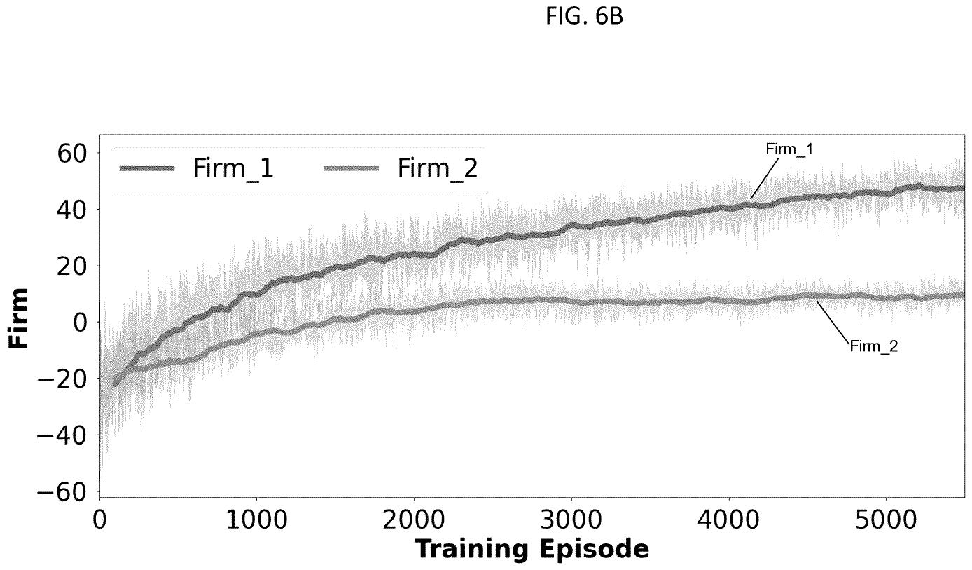

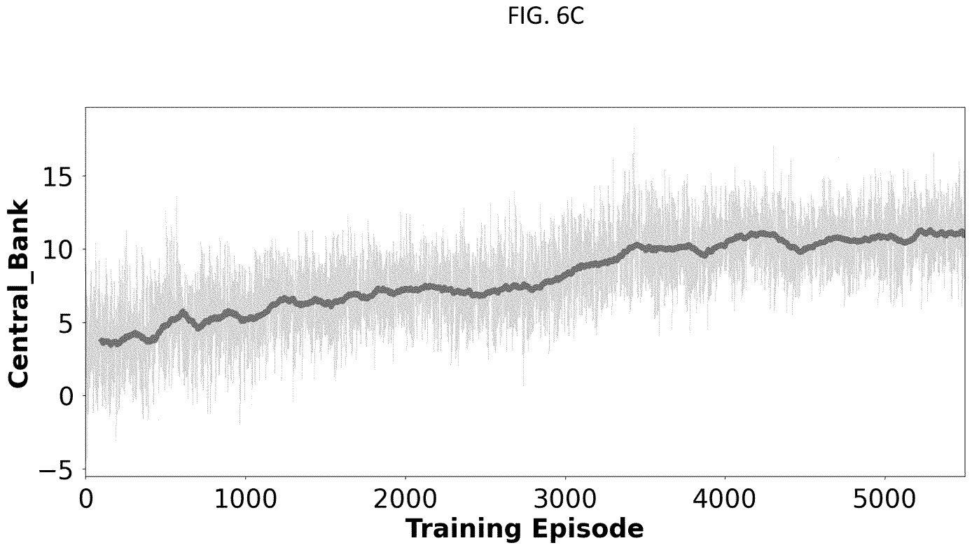

σ=0.1, and weighting for inventor risk χ=0.1. The technology firm being less labor intensive has production elasticity α₁=2/3, while the agriculture firm has production elasticity α₂=1. The central bank has a target inflation rate π*=1.02, production weight λ=0.25 and discount factor βCB=0.99. The government collects income taxes at a fixed rate of τ₁=0.2457, and does not redistribute any tax credits so that ξ=0. FIGS. 6A-6C illustrate plots of discounted cumulative rewards during training for all learning agents as a function of training episodes. The shaded lines show the per episode rewards with solid lines showing their moving average, where training convergence may be observed.

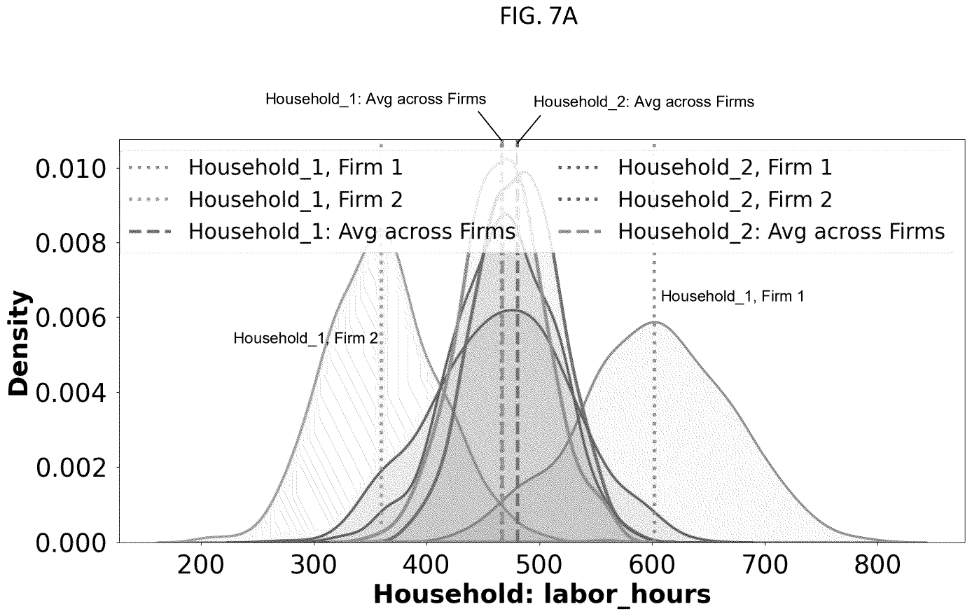

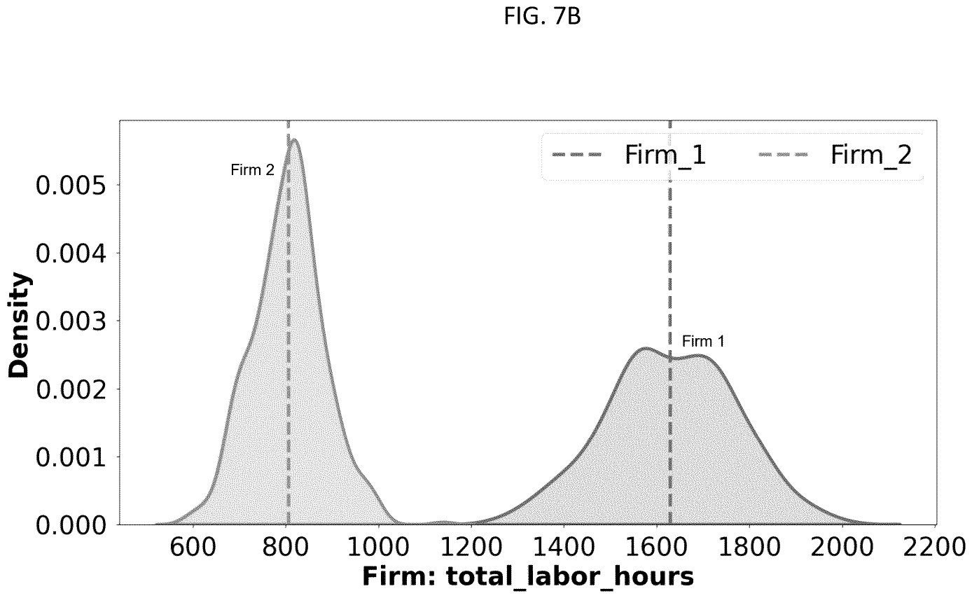

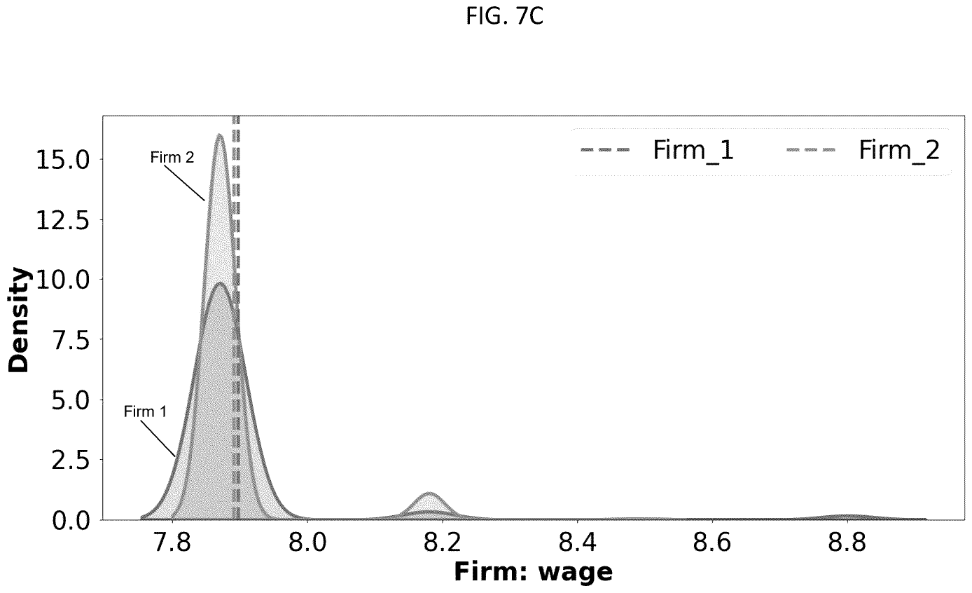

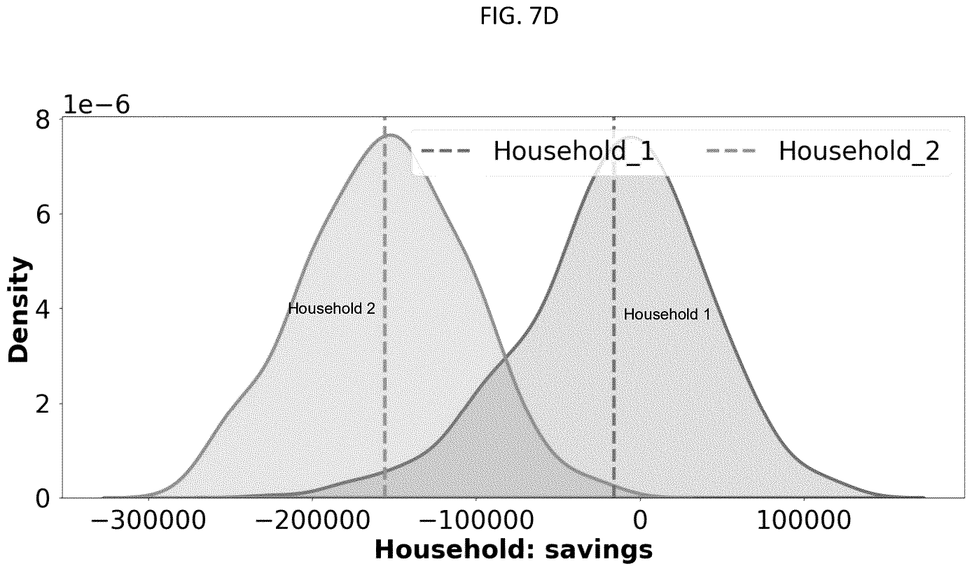

Learned policies may be played out in 500 test episodes to collect observations on the strategies adopted by the heterogeneously skilled households as illustrated in FIGS. 7A-7D. FIG. 7A shows the distribution across test episodes of average labor hours of households per firm (and across both firms). Based on FIG. 7A, household 1 is observed to be more skilled at firm 1 has the highest labor hours at firm 1. Also, household 2 that is similarly skilled at both firms has similar labor hours across them. FIGS. 7B-7C illustrate the total labor hours received by the firms alongside the wages they pay per hour of labor. As shown in FIGS. 7B-7C, even though both firms pay similar wages, firm 1 receives higher labor as a result of the preference of household 1. FIG. 7D illustrates resulting savings of both households, where saving increase is shown as household skill increases. Household 1 has a higher savings despite both households having the same savings utility weight μ.

Based on FIGS. 7A-7D, it may be observed that households align their labor hours to firms at which they are more skilled at, even when both firms pay the same wages. Further, a household that has higher skills across both firms accumulates higher savings over the horizon even with the same propensity to save.

In operation 407, once the simulation has stabilized, one or more shocks is introduced to a computer agent. In an example, exogenous shock may include an advent of a new technology, a disease outbreak, a natural disaster, a global conflict and the like. However, aspects of the present disclosure are not limited thereto, such that other exogenous shocks may be included. Further, in response to the introduced one or more shocks, reactionary data from the at least two independent computer agents are captured in operation 408.

For example, production processes of firms agent may be affected by an exogenous production factor that captures any shocks. In this scenario, a positive shock to the production of a technology firm to model the advent of Large Language Models and their chat versions. The intuition is that such technologies could improve average production of technology firms, albeit with an increase in production variability. Further, the impact of such a shock on strategies of the technology firms as well as those of non-technology firms are evaluated.

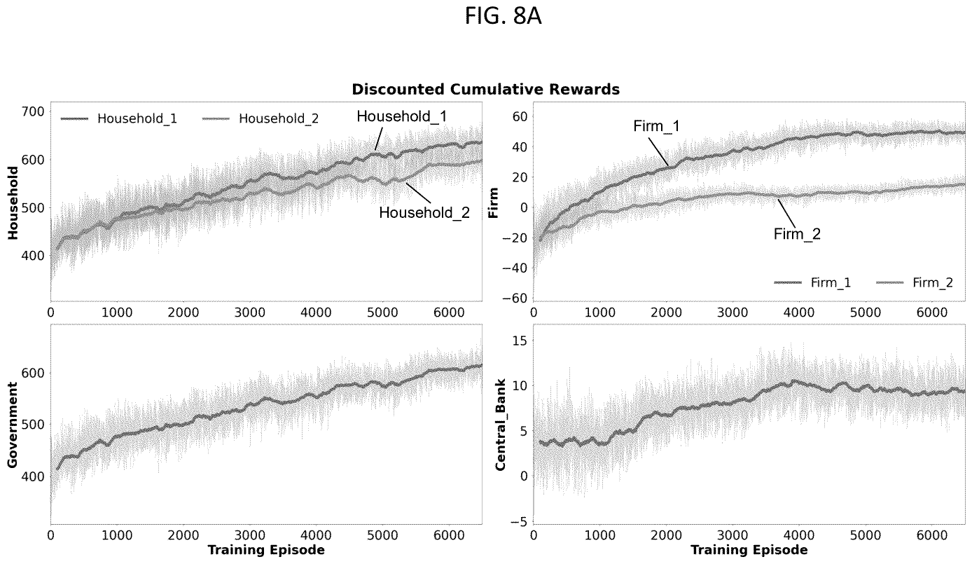

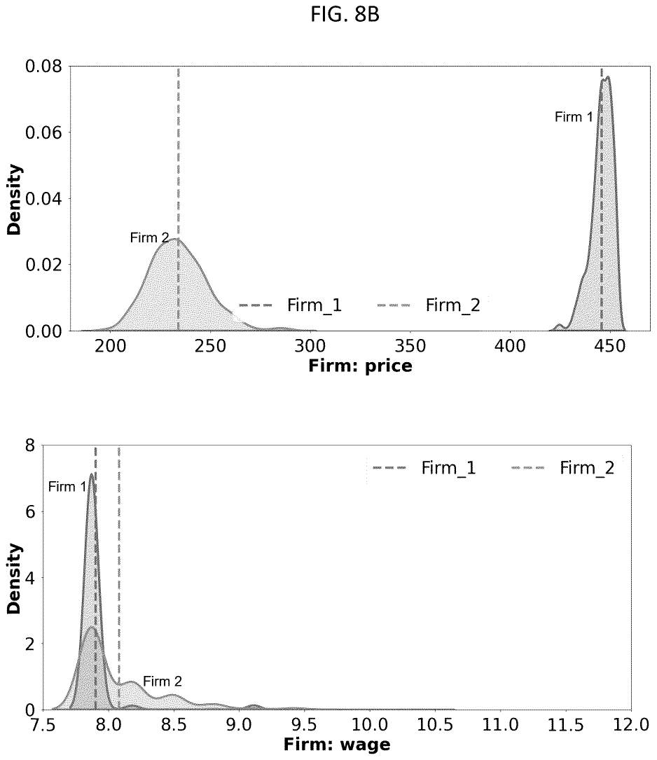

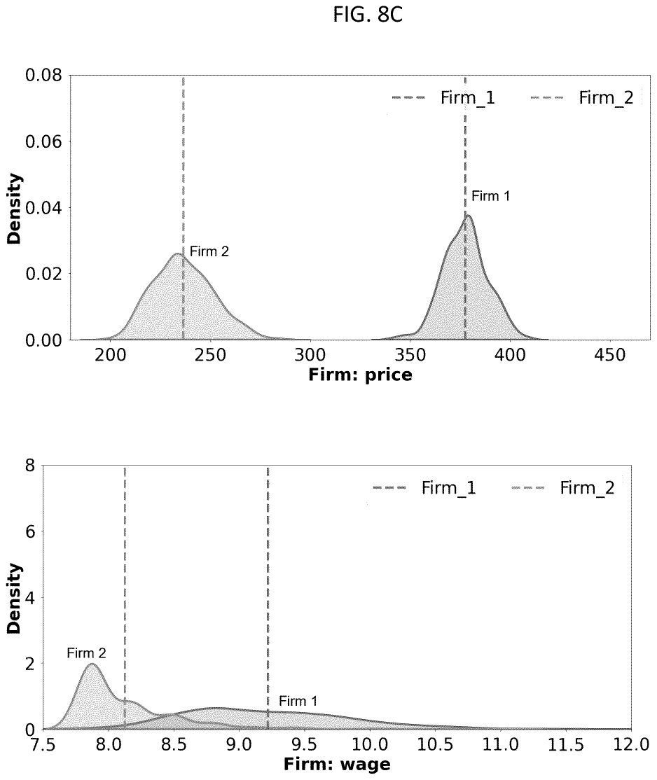

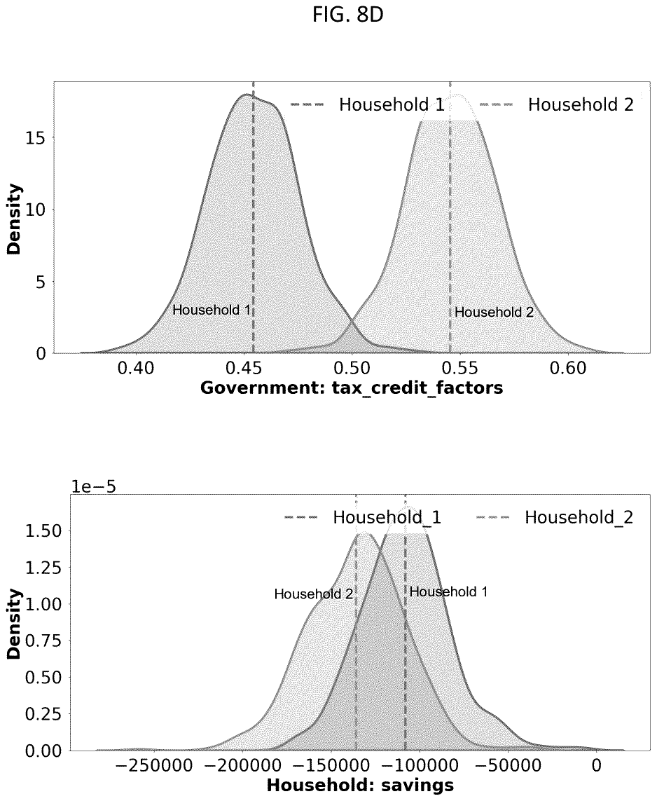

In this scenario, the government agent is equipped with reinforcement learning. In this example, the simulation model includes 2 households agents, 2 firms agents, a central bank agent and a government agent as learning agents over a horizon of 10 years or 40 quarters. Here, the government distributes 10% of collected taxes as credits to households, with parameters ξ=0.1, β_{G}=0.99 and household weight parameters αl=1, β₁=1.2, l₁=10⁻³ and l₂=β₁+2α₁=3.2 in equation (6). Neither firm experiences a production shock while training so that both have shock process parameters of ρⱼ=0.97, ε̅ⱼ=0 and σⱼ=0.1 for j∈{1, 2} during training. FIG. 8A plots discounted cumulative rewards during training for all learning agents as a function of training episodes demonstrating training convergence.

At test time, a positive shock to the technology firm 1 is introduced by setting its shock parameters as ε̅ⱼ=0.3 and σ1=0.2. The learned policies are then played out in test episodes with and without the shock, to collect observations on the strategies adopted by both firms. FIG. 8B shows the distribution of prices, wages set by firms in absence of shock. FIG. 8C shows the same in presence of a positive shock to firm 1. The upper graph of FIG. 8B shows prices without the shock where it is observed that the agriculture firm sets lower prices than the technology firm. This is because firm 2 produces more with the same amount of labor as firm 1 (see equation (4) for elasticity αⱼ), and thereby accumulate higher inventory. It prices its goods cheaper to reduce its accumulated inventory. Once the technology firm experiences a positive shock that increases its production (see equations (3) and (4) for shock value ϵ_{1,j}), and subsequently its inventory, a reduction in its price in response to the shock may be observed in upper graph of FIG. 8C. Similarly, from the bottom graphs of FIGS. 8B and 8C, it may be observed that wages of firm 1 increase with a positive shock. Accordingly, case may be made that firm 1 tries to draw more consumption from households to clear out its increased inventory from the shock by reducing prices and increasing wages.

Accordingly, from the above noted disclosures with respect to FIGS. 8B and 8C, it may be observed that the firm experiencing a positive production shock that increases its inventory reacts by reducing prices and increasing wages. This is done to incentivize household consumption of its goods, and thereby reduce inventory.

Based on the above noted scenario, learned government policy when tested in absence of the production shock is examined. FIG. 8D illustrates the fraction of tax credit distributed to the two households f_{t,i} on the top, along with the household savings m_{t,i} on the bottom. From FIG. 8D, it may be observed that household 2 with lower savings is allotted more tax credit by the government agent due to its higher weighting in equation (6). Accordingly, the government agent redistributes a portion of the collected income taxes as credits towards improving social welfare by focusing on the poorer households.

FIGS. 5A-5C illustrate multi-agent simulation performed at differing levels of organizations accordance with embodiments. FIG. 5A illustrates an example macroeconomic simulation at a country level.

According to example aspects, the multi-agent simulation implemented by the MASILA system may be applied to provide a simulation model of economies at different levels, such as at a national or country level, state or regional level or at an international level. However, aspects of the present disclosure are not limited thereto, such that the multi-agent simulation may be applied to different environments, such as manufacturing plants, weather systems, or the like.

As illustrated in FIG. 5A, the multi-agent macroeconomic simulation model may include four computer agent types, including a households agent type, a firms agent type, a government agent type and a central bank agent types. Each of the agent types may include one or more agents. For purpose of simplicity, a singular agent may be referenced. Although four agent types are disclosed herein, aspects of the present disclosure are not limited thereto, such that the simulation model may include more or less agent types.

In an example, the households agent type or agent may represent consumers of goods and providers of labor for the production of goods. The firms agent type or agent may utilize labor to produce goods and pay wages. The central bank agent type or agent may monitor price inflation and production to set interest rate for households agent's and firms agent's savings. The government agent type or agent may collect income taxes from households and firms agents that could potentially be redistributed as tax credits.

According to example aspects, each of the above noted agents or agent types may have their individual objectives, which may be modeled as learners trying to maximize discounted sum of their reward functions over a horizon H. The multi-agent simulation model with multiple reinforcement learning agents may be formalized as a Markov Game (MG) with each agent having partial observability of the global system state. A finite horizon Partially Observable Markov Game (POMG) may be denoted by

$$Γ = 〈 𝒩 , 𝒮 , {\{ {𝒜}_{i} \}}_{i = 1}^{n} , {\{ {𝒪}_{i} \}}_{i = 1}^{n} , 𝕋 , {\{ {𝕆}_{i} \}}_{i = 1}^{n} , {\{ {R}_{i} \}}_{i = 1}^{n} , {\{ {β}_{i} \}}_{i = 1}^{n} , H 〉$$

where
N={1, 2, . . . , n} is the set of agents
S is the state space
Aᵢ is the action space of agent i with A=A₁×A₂× . . . ×Aₙ denoting the joint action space
Oᵢ is the observation space of agent i
T: S×A→P(S) is the transition function mapping the current state and joint action to a probability distribution over the next state
Oᵢ: S→P(Oᵢ) is the observation function mapping the current state to a probability distribution over observations of agent i
Rᵢ: S×A→R is the reward function of agent i
βᵢ∈[0, 1) is the discount factor of agent i
H is the horizon

The objective of each agent i∈N in a POMG is to find a sequence of their own actions that maximizes their expected sum of discounted rewards over the horizon

$${max}_{( {a}_{i} ( O ) , … , {a}_{i} ( H - 1 ) )} 𝔼 [ {\sum }_{t = 0}^{H - 1} {β}_{i}^{t} {R}_{i} ( s ( t ) , {a}_{1} ( t ) , … , {a}_{n} ( t ) ) ]$$

where s(t+1)~T(s(t), a₁(t), . . . , aₙ(t))∀t. Here t may denote a time step of simulation (e.g., one quarter). Further, index i may represent households agent and index j may represent firms agent.

In further detail, households agent or agent type may represent consumer-workers that provide labor for production at firms, while also consuming some of the produced goods. They may be paid wages for their labor at the firms and pay for the price of consumed goods. The government agent or agent type may collect income taxes on their labor income, part of which may be redistributed back to households as tax credits in the subsequent year. They may also earn (or accrue) interest on their savings (or debt) from the central bank. These inflows and outflows may govern the dynamics of household savings from one time step to the next.

According to further aspects, the observations of the households agent i at time t may include tax credit κ_{t,i}, tax rate τₜ, interest rate rₜ, wages of all firms {w_{t,j}: ∀j}, prices of goods of all firms {p_{t,j}: ∀j} and their monetary savings m_{t,i}.

Further, the actions of the households agent i include their hours of labor for all firms {n_{t,ij}: ∀j} and the units of good requested for consumption at all firms

$$\{ {c}_{t , ij}^{req} : ∀ j \} .$$

Also, dynamics related to the households agent i are given by

$${c}_{t , ij} = min \{ {c}_{t , ij}^{req} , {Y}_{t , j} \cdot \frac{{c}_{t , ij}^{req}}{{\sum }_{k} {c}_{t , kj}^{req}} \} \qquad ( 1 )$$

$$\begin{matrix}{m}_{t + 1 , i} = ( 1 + {r}_{t} ) {m}_{t , i} + {\sum }_{j} ( {n}_{t , ij} {ω}_{t , j} - {c}_{t , ij} {p}_{t , j} ) \\ - {𝒯}_{t} \cdot {\sum }_{j} {n}_{t , ij} {ω}_{ij} {ω}_{t , j} + {κ}_{t , i}\end{matrix} \qquad ( 2 )$$

Based on the above, equation (1) handles the case when the requested consumption per firm agent j exceeds its inventory Y_{t,j}. Here, goods may be distributed proportionally to their requests, to give the realized consumption for household agent i of goods of firm j at t as c_{t,ij}². Equation (2) refers to evolution of savings from t to t+1 where ωᵢⱼ denotes the skill of household agent i at firm agent j.

The reward for the household agent I at t is given by the following:

$$\begin{matrix}{\sum }_{j} u ( {c}_{t , ij} , {n}_{t , ij} , {m}_{t + 1 , i} ; {γ}_{i} , {v}_{i} , {μ}_{i} ) where \\ u ( c , n , m ; γ , v , μ ) = \frac{{c}^{1 - γ}}{1 - γ} - {vn}^{2} + μ \cdot sign ( m ) \frac{{\vert m \vert}^{1 - γ}}{1 - γ} \}\end{matrix}$$

with an isoelastic utility from consumption and savings, and a quadratic disutility of labor.

Moreover, households are heterogeneous in their skills per firm and example parameters of their utility function are listed in the below noted heterogeneity parameters table.

| Agent | Heterogeneity Parameter |
|---|---|
| Household i | ωᵢⱼ: Skill level per firm j |
| | γᵢ: Isoelasticity parameter |
| | νᵢ: Weighting of labor disutility |
| | μᵢ: Weighting of savings utility |
| | β_{i, H}: Discount factor |
| Firm j | ρⱼ, ε̅ⱼ, σⱼ: Exogenous shock process |
| | αⱼ: Production elasticity for labor |
| | χⱼ: Weighting of inventory risk |
| | β_{j, F}: Discount factor v |

In further detail, firms agent or agent type may represent producer-employers that use household agent labor to produce goods for consumption. The producer-employers may pay wages for the received labor and receive revenue from prices paid for consumer goods. Their production may be subject to an exogenous, stochastic production factor that captures one or more external shocks. Firms agent or agent type may accumulate inventory when they produce more goods than consumed by households, which they may seek to minimize. The government agent or agent type may collect income taxes from the firms agent, part of which may be redistributed back to firms agent as tax credits in the subsequent year. The firms agent may also collect interest from the central bank agent and/or pay interest to the central bank agent.

According to example aspects, the observations of the firm agent j at time t may include total household labor Σᵢn_{t,ij}ωᵢⱼ, total consumption Σᵢc_{t,ij}, exogenous shock ε_{t,j}, exogenous production factor ϵ_{t-1,j}, previous wage ω_{t,j}, previous price p_{t,j} and inventory Y_{t,j}.

According to example aspects, the actions of the firm agent j include wage per unit of labor ω_{t+1,j} and price per unit of good p_{t+1,j} that go into effect at the next time step.

According to example aspects, the dynamics of quantities related to the firm agent j are given by the following:

$${ϵ}_{t , j} = {( {ϵ}_{t - 1 , j} )}^{ρ j} exp ( {ϵ}_{t , j} ) \qquad ( 3 )$$

$${y}_{t , j} = {{ϵ}_{t , j} ( {\sum }_{i} {n}_{t , ij} {ω}_{ij} )}^{{α}_{j}} \qquad ( 4 )$$

$${Y}_{t + 1 , j} = {Y}_{t , j} + {y}_{t , j} - {\sum }_{i} {c}_{t , ij} \qquad ( 5 )$$

Based on the above, the equation (3) provides dynamics of the exogenous production factor ϵ_{t,j} using a log-autoregressive process with coefficient ρⱼ∈[0, 1], ϵ_{0,j}=1, with

$${ε}_{t , j} \sim {N}^{( {\overline{ε}}_{j} , {σ}_{j}^{2} )}$$

being an exogenous shock. Equation (4) is the firm agent's production process per a Cobb-Douglas production function using skilled labor with elasticity parameter αⱼ∈[0, 1]. The firm agent may update its inventor at the next time step based on current inventory and the difference between supply and demand as shown in equation (5) provided above.

According to further aspects, the reward for the firm agent j at time step t is given by:

$${p}_{t , j} {\sum }_{i} {c}_{t , ij} - {ω}_{t , j} {\sum }_{i} {n}_{t , ij} {ω}_{ij} - {χ}_{j} {p}_{t , j} {Y}_{t + 1 , j}$$

where the first two terms represent monetary profits as the difference in revenue from consumed goods and wages paid, with the last term capturing the risk of accumulated inventory. According to further aspects, the firms may be heterogeneous in their sector, equivalently modeled by the shock process and production function that turns labor into goods. The heterogeneity parameters related to firms are described in the heterogeneity parameters table noted above.

In further detail, the central bank agent or agent type may refer to a regulatory agency that monitors prices and production of goods to set interest rates for household savings. By changing the interest rate on household savings, it affects the consumption and labor patterns of the household. These in turn affect the prices of goods produced by the firms agent. The central bank agent may seek to set interest rates to meet inflation targets and boost production.

According to exemplary aspects, the observations of the central bank agent at time step t include total price of goods over the last five time steps (e.g., five quarters) {Σⱼp_{t-k,j}: ∀k∈{0,1,2,4}} and total production across firms Σⱼy_{t,j}.

According to further aspects, the action of the central bank agent includes the interest rate rₜ₊₁ that goes into effect at the next time step.

The dynamics related to the central bank agent are given by:

$${π}_{t} = \frac{{\sum }_{j} {p}_{t , j}}{{\sum }_{j} {p}_{t - 4 , j}}$$

where πₜ is the annual inflation in total price.

The reward for the central bank is given by:

$$- {( {π}_{t} - {π}^{★} )}^{2} + λ {( {\sum }_{j} {y}_{t , j} )}^{2}$$

where π* is the target inflation rate. And, λ>0 weighs the production reward in relation to meeting the inflation target.

In further detail, the government agent or agent type may refer to a regulatory agency that collects taxes from households agent on their labor income in order to maintain infrastructure. The government agent may set an income tax rate and may choose to distribute a portion of the collected taxes back to households agent as tax credits in order to improve household social welfare.

According to example aspects, the observations of the government agent at time step t may include the previous tax rate τₜ, previous tax credits {κ_{t,i}: ∀i}, previous tax collected {τₜ Σⱼ n_{t,ij}ωᵢⱼw_{t,j}: ∀i} and a time varying weight associated to each household in relation to social welfare {l_{t,i}: ∀i}. The multi-agent simulation model allows a selection of weights l_{t,i} based on their choice of social welfare metric e.g., l_{t,i}≡1 for the utilitarian social welfare function versus l_{t,i}=1 {i=arg minₖ m_{t,k}} for the Rawlsian social welfare function. In an example, l_{t,i} may be selected to be a linear function of household savings at t with parameters α₁>0, β₁>0, and clipped to lie in the range [l₁, l₂] with l₂>l₁>0 as:

$${l}_{t , i} = \{ \begin{matrix}max \{ {l}_{1} , - {α}_{l} {m}_{t , i} + {β}_{l} \} , & if {m}_{t , i} > 0 \\ min \{ {l}_{2} , - 2 {α}_{l} , {m}_{t , i} + {β}_{l} \} , & if {m}_{t , i} \leq 0\end{matrix} \qquad ( 6 )$$

According to further aspects, equation (6) may give weights that decrease with an increase in household savings for when savings are positive. When savings are negative or non-positive, the weight increases with increase in household debt. Accordingly, the government agent may under-weigh households that have high savings and over-weighs households that have high debts while ensuring all households are weighted at least l₁>0, and no household gets weighted higher than l₂.

Further, the actions of the government agent may include the tax rate τₜ₊₁, and the fraction of tax credit distributed to each household if_{t+1,i} that go into effect at the next time step.

Moreover, the dynamics related to the government agent are given by:

$${κ}_{t + 1 , i} = \dot{ξ} {f}_{t + 1 , i} {\sum }_{k} ( {𝒯}_{t} {\sum }_{j} {n}_{t , kj} {ω}_{kj} {ω}_{t , j} ) \qquad ( 7 )$$

where f_{t,i}∈[0, 1] with Σᵢ f_{t,i}=1 so that a portion ξ∈[0, 1] of all collected taxes are redistributed.

Here, equation (7) may give tax credit for household i at time step t+1 as a fraction f_{t+1,i} of the ξ portion of total income collected at time step t.

In addition, the reward for the government agent may be a measure of household social welfare, computer herein as a weighted sum of household utilities as:

$${\sum }_{i} {l}_{t , i} {R}_{t , i , H}$$

where l_{t,i} is the weight associated to household i and, R_{t,i,H}=Σᵢu(c_{t,ij},n_{t,ij},m_{t+1,i};γᵢ,νᵢ,μᵢ) may be the reward function measuring the utility for household i at time step t.

According to example aspects, each of the computer agents illustrated in FIG. 5A may be limited to their respective internal states, such that one computer agent is unaware of the information being processed by the other computer agents. However, each of the computer agents may send and receive messages from other computer agents. As illustrated in FIG. 5A, the households agent may transmit skilled labor data and consumption data to the firms agent. The households agent may also transmit taxes data to the government agent. The households agent may receive messages including wages data and prices data from the firms agent, receive messages including tax rate data and tax credit data from the government agent, and receive a message including interest rate data from the central bank agent. Also, the firms agent may transmit messages including prices data and production data to the central bank.

FIG. 5B illustrates an example micro-economic simulation at a state/region level. As illustrated in FIG. 5B, the micro-economic simulation model may include similar agent or agent types as the macro-economic simulation model in FIG. 5A, but may include additional agents or agent types in view of the higher granularity in the simulation model. For example, the households agent may exchange messages with the commercial banks agent, as opposed to the central bank agent. Further, the micro-economic simulation may additionally include retail firms agent and commercial banks agent in addition to the households agent, firms agent, central bank agent and the government agent.

Similar to the simulation model in FIG. 5A, each of the agents or agent types of FIG. 5B may be limited to their respective internal states. However, the independent computer agents may communication with one another by messages via the identified communication channels. More specifically, at least since agents may be limited to accessing their internal states, any information from other computer agents is to be requested using messages. Recipients of messages may respond by sharing a part of their internal states with the sender.

As illustrated in FIG. 5B, the retail firms agent may exchange messages with respect to supply data with the firms agent. Further, the retails firms agent may exchange messages indicating labor data and consumption data with the households agent, and may exchange messages indicating loans data and interest data with the commercial bank agent. Lastly, the retail firms agent may exchange messages indicating taxes data with the government agent. Also, the commercial bank agent may exchange messages indicating monetary policy data with the central bank agent, and may exchange messages with the firms agent, the retail firms agent and the households agent for indicating loans interest data. The commercial bank agent may also exchange messages indicating taxes data with the government agent.

FIG. 5C illustrates an example economy interaction simulation between countries at an international level. In addition to the country level simulation model of FIG. 5A and state or regional level simulation model of FIG. 5B, an international level simulation model may be established as shown as an example in FIG. 5C. In FIG. 5C, each of the country level simulation models for each of the respective countries may interact with one another. More specifically, the country or macrolevel simulation model of the United States of America (USA) may interact with country or macro level simulation models of Russia, Japan and China. Each of the respective simulation models may exchange message including loan data, trade deficit/surplus data, gross domestic product (GDP) data and the like.

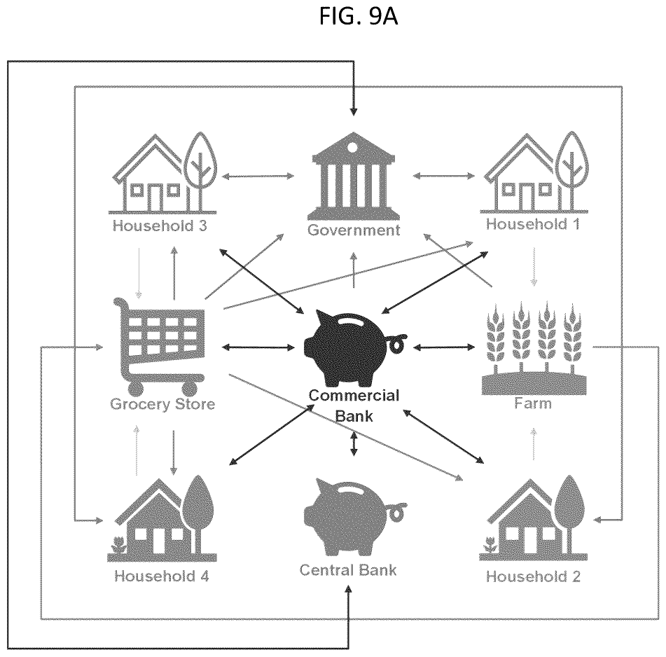

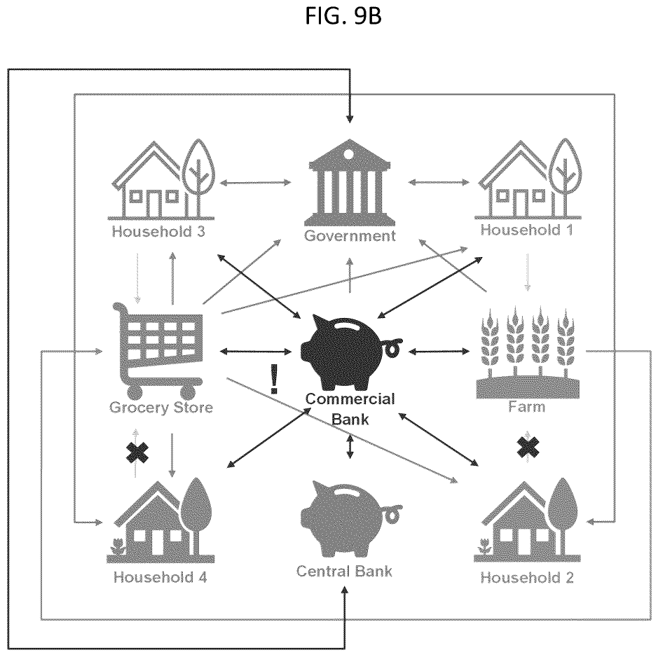

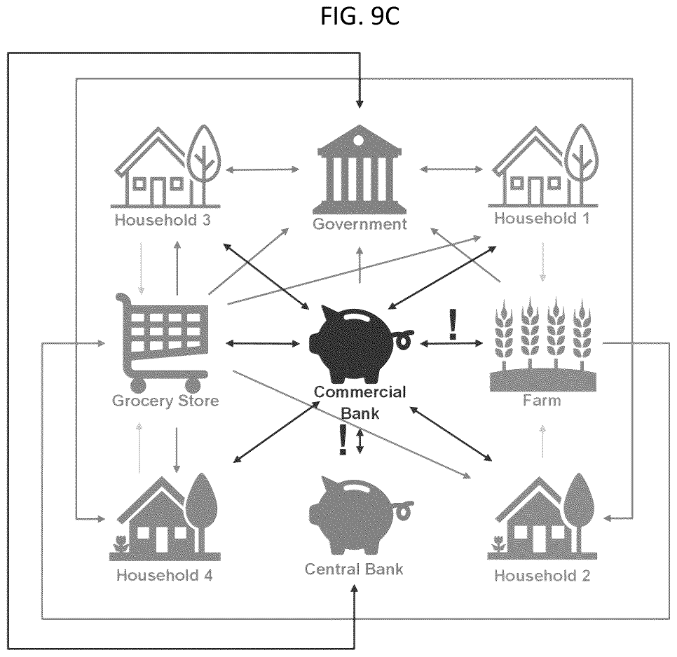

FIGS. 9A-9C illustrate examples of scenarios in response to a sample impact in accordance with embodiments.

As shown in FIG. 9A, a multi-agent simulation model may include nine independent computer agents, of five different agent types. More specifically, the agent types may include households agent type, firms agent type, a government agent type, a central bank agent type and a commercial bank agent type. The households agent type includes household 1 agent, household 2 agent, household 3 agent, and household 4 agent. The firms agent type includes farm agent and grocery store agent. Here, each of the respective agents may provide certain resources or data to other agents. For example, household 1 agent and household 2 agent may provide labor to the farm agent, and the commercial bank agent may provide loans to the farm agent and the grocery store agent. As noted above, each of the agents of the same type, while sharing certain similarities (e.g., providing of labor), may have different sensitivities based on its attributes or parameters. Moreover, each of the agents in the simulation model may act independently to optimize its respective rewards or values.

In the scenario illustrated in FIG. 9B, the farm agent may decide employment based on expected demand, and may desire production based on desired inventory buffer. This figure demonstrates a scenario of simulating the impact when the farm becomes more sensitive to inventory holding risk. As a result, the decrease in desired inventory buffer may in turn decrease the desired production. Based on the desire for decreased production, a resulting employment decrease may ensue. This action by the farm agent may cause a response by the central bank agent to lower GDP, which may in turn cause the government agent to pay more in unemployment benefits to the household agents. Further, due to lower incomes of household agents facing unemployment or underemployment, the grocery store agent may face lower demand. As a result, the grocery store agent may react to employ fewer households.

In the scenario illustrated in FIG. 9C, the commercial bank agent may be allowed to only loan out a proportion of equity as specified by regulation issued by the central bank agent. This figure demonstrates a scenario of simulating the impact when the central bank agent may increase capital requirement for the commercial bank agent, such as minimum capital adequacy ratio. Based on the changes implemented by the central bank agent, loan approval or loan approval amount for the farm agent may be reduced. Lower investment in the farm agent may cause lowered production for the farm agent. Due to the lowered fulfilled demand by the farm agent, the grocery store agent may result in lower taxes paid to the government agent. In this case, the central bank may need to respond to the lower taxes collected by the government agent which causes higher deficit along with lowered GDP.

As provided above in view of various examples, the multi-agent simulation model captures reactionary data by various independent computer agents in the simulation model at subsequent levels, which was unable to be captured under the conventional single agent-based simulation models. While the conventional single agent-based simulation models may be able to capture immediate results to other data entities in response to an action by the single agent, the conventional single agent based simulation models are unable to capture reactions or modified actions of the impacted agents, which may consequentially impact the single agent further down the line. In contrast, at least since the multi-agent simulation models allows for each of the agents to operate independently to optimize its respective benefits and perform individual reinforcement learning, downstream effects may be more accurately captured.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the present disclosure in its aspects. Although the invention has been described with reference to particular means, materials and embodiments, the invention is not intended to be limited to the particulars disclosed; rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium may be a random-access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application specific integrated circuits, programmable logic arrays and other hardware devices, may be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, may be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

What is claimed is:

1. A method for performing a multi-agent simulation for capturing reactionary actions by a downstream computer agent, the method comprising:
generating, by a processor, a simulation model with at least two independent computer agents with at least one communication provided between the at least two independent computer agents;
initializing each of the at least two independent computer agents;
executing, by the processor, the simulation model for performing a simulation until a stable state is established in the simulation;
initiating, by the processor, at least one exogeneous shock to the simulation model after the stable state is established in the simulation;
capturing, by the processor, reactionary data from the at least two independent computer agents; and
independently performing, by the processor and via machine learning, reinforcement learning for each of the at least two independent computer agents.

2. The method according to claim 1, wherein each of the at least two independent computer agents are limited to its respective internal states.

3. The method according to claim 2, wherein a first independent computer agent of the at least two independent computer agents is configured to receive a message from a second independent computer agent to obtain select data of the second independent computer agent, and
wherein the second independent computer agent of the at least two independent computer agents is configured to receive a message from the first independent computer agent to obtain select data of the first independent computer agent.

4. The method according to claim 1, wherein each of the at least two independent computer agents is configured to optimize its respective reward.

5. The method according to claim 1, wherein each of the at least two independent computer agents is configured to independently perform reinforcement learning.

6. The method according to claim 1, wherein each of the at least two independent computer agents is of a different agent type among a plurality of agent types.

7. The method according to claim 6, wherein the plurality of agent types includes a households agent type, a firms agent type, a government agent type, a central bank agent type.

8. The method according to claim 1, wherein each of the at least two independent computer agents includes four or more different agent types.

9. The method according to claim 6, wherein at least one of the plurality of agent types includes a plurality of agents with differing heterogeneity parameters.

10. The method according to claim 1, wherein the stable state is determined at each predetermined time step after the simulation model is executed.

11. The method according to claim 1, wherein the at least one exogeneous shock includes an advent of a new technology, a disease outbreak, a natural disaster, a global conflict.

12. The method according to claim 1, wherein the reactionary data includes a modified action performed by at least one of the at least two independent computer agents in response to the exogenous shock.

13. The method according to claim 9, wherein the differing heterogeneity parameters are acquired from at least one of literature and real world data.

14. The method according to claim 1, wherein the at least one exogeneous shock is embedded in the simulation model.

15. The method according to claim 1, further comprising:
acquiring, by the processor, data for building the simulation model, the data including historical data and/or reference data; and
identifying a plurality of data entities included in the acquired data, dataflows between the plurality of data entities, types of the data entities and variations within the types of data entities, wherein the at least two independent computer agents correspond to the plurality of data entities identified.

16. The method according to claim 1, further comprising:
selecting a granularity level of the multi-agent simulation.

17. The method according to claim 16, wherein the granularity level includes a country level, a state or regional level and an international level.

18. A system for performing a multi-agent simulation for capturing reactionary actions by a downstream computer agent, the system comprising:
a processor; and
a memory operatively connected to the processor via a communication interface, the memory storing computer readable instructions, when executed, causes the processor to:
generating a simulation model with at least two independent computer agents with at least one communication provided between the at least two independent computer agents;
initializing each of the at least two independent computer agents;
executing the simulation model for performing a simulation until a stable state is established in the simulation;
initiating at least one exogeneous shock to the simulation model after the stable state is established in the simulation;
capturing reactionary data from the at least two independent computer agents; and
independently performing, via machine learning, reinforcement learning for each of the at least two independent computer agents.

19. A non-transitory computer readable medium configured to store instructions for performing a multi-agent simulation for capturing reactionary actions by a downstream computer agent, the instructions, when executed, cause a processor to perform the following:
generating a simulation model with at least two independent computer agents with at least one communication provided between the at least two independent computer agents;
initializing each of the at least two independent computer agents;
executing the simulation model for performing a simulation until a stable state is established in the simulation;
initiating at least one exogeneous shock to the simulation model after the stable state is established in the simulation;
capturing reactionary data from the at least two independent computer agents; and
independently performing, via machine learning, reinforcement learning for each of the at least two independent computer agents.
